(19) United States
(12) Patent Application Publication
(10) Pub. No.: US 2022/0411729 A1
(43) Pub. Date: Dec. 29, 2022

(54) METHOD OF ENHANCING A SPIRIT WITH ANOTHER SPIRIT, AND A SPIRIT ENHANCED SPIRIT

(71) Applicant: James Joseph Sanctified Spirits, LLC, Westlake, TX (US)

(72) Inventor: Joseph Giildenzopf, Westlake, TX (US)

(21) Appl. No.: 17/848,112

(22) Filed: Jun. 23, 2022

Related U.S. Application Data
(60) Provisional application No. 63/214,607, filed on Jun. 24, 2021.

(51) Int. Cl. C12G 3/04; C12G 3/08

(52) U.S. Cl. CPC C12G 3/04; C12G 3/08

(57) ABSTRACT

Enhancing a spirit by mixing in one or more other spirit during manufacturing is disclosed. The primary spirit, i.e., the spirit being enhanced, and the one or more additional spirits, i.e., the secondary spirits, can be a distilled spirit, a non-distilled spirit, an aged spirit, a finished spirit, a spirit that is neither aged nor finished, and any combination thereof. In one aspect, the disclosure provides a method of producing a spirit enhanced spirit (SES). In one example, the method includes: (1) obtaining a primary spirit, (2) adding one or more secondary spirit to the primary spirit, wherein the one or more secondary spirit is a different type of spirit than the primary spirit, (3) placing the primary spirit and the one or more secondary spirit in a bottle, wherein combination of the primary spirit with the one or more secondary spirit produces a SES, and (4) sealing the bottle.

### CROSS-REFERENCE TO RELATED APPLICATION

This application claims the benefit of U.S. Provisional Application Ser. No. 63/214,607, filed by Joseph Giildenzopf on Jun. 24, 2021, entitled “A METHOD OF ENHANCING A SPIRIT WITH ANOTHER SPIRIT, AND A SPIRIT ENHANCED SPIRIT,” commonly assigned with this application and incorporated herein by reference in its entirety.

### TECHNICAL FIELD

This application is directed, in general, to producing spirits and, more specifically, to producing an enhanced spirit.

### BACKGROUND

A distilled spirit, also referred to as a distilled beverage, liquor, hard liquor or hard alcohol, is an alcoholic beverage produced by distillation of fermented grains, fruit, or vegetables. Some distilled spirits, such as whiskey, bourbon, scotch, and different types of tequila and rum are aged after distillation. Aging is a process of storing the distilled spirits in wood barrels for an amount of time to add distinct flavors and remove harsh flavors from the raw alcohol. The wood barrels are typically constructed of toasted wood that interacts with the distilled spirit to contribute organic compounds and transforms acids into esters to give spirits their unique flavor.

The distilled spirit obtains distinct flavors from the different types of wood that are used for the barrels. In addition to distinct flavors, aging also adds color to the clear distilled spirits. The amount of time and the type of wood barrels can be specified for some distilled spirits. For example, all Scotch whisky must be aged in oak barrels for at least three years. Once a distilled spirit is aged, it is removed from the wood barrel and is bottled for distribution or later consumption.

Some distilled spirits are not aged in wood barrels after distillation. For example, vodka and gin are typically not aged and remain clear. Different types of tequila and rum are also not aged in wood barrels and remain clear. For example, silver tequila may be briefly aged in glass bottles or steel tanks but remains a clear liquid.

Regardless if aged or not, in contrast to wines distilled spirits do not improve with age once placed in bottles after manufacturing. For example, if aged the maturation of the distilled spirit ends when removed from the wood barrels. The taste of the unopened whiskey, rum, etc. remains the same or essentially the same while bottled and waiting on the shelf.

### SUMMARY

In one aspect, the disclosure provides a method of producing a spirit enhanced spirit (SES). In one example, the method includes: (1) obtaining a primary spirit, (2) adding one or more secondary spirit to the primary spirit, wherein the one or more secondary spirit is a different type of spirit than the primary spirit, (3) placing the primary spirit and the one or more secondary spirit in a bottle, wherein combination of the primary spirit with the one or more secondary spirit produces a SES, and (4) sealing the bottle.

In another aspect a method of producing a SES for commercial distribution is disclosed. In one example, this method of producing a SES includes: (1) obtaining a primary spirit, (2) adding one or more secondary spirit to the primary spirit, wherein the one or more secondary spirit is a different type of spirit than the primary spirit, (3) placing the primary spirit and the one or more secondary spirit in a bottle, (4) placing at least one wood piece in the bottle, and (5) sealing the bottle, having located within the bottle both the primary spirit, the one or more secondary spirit, and the wood piece.

In yet another aspect, the disclosure provides a method of manufacturing a spirit enhanced spirit (SES) for commercial sale. In one example, the method of manufacturing includes: (1) obtaining a primary spirit that is a base liquor, (2) adding at least one secondary spirit to the primary spirit, wherein the at least one secondary spirit is a different base liquor than the primary spirit, (3) placing the primary spirit and the at least one secondary spirit in a bottle, wherein combination of the primary spirit with the one or more secondary spirit produces a SES, (4) sealing the bottle, and (5) placing a label on the bottle, wherein the label identifies the SES as the primary spirit and includes the secondary spirit.

### BRIEF DESCRIPTION

Reference is now made to the following descriptions taken in conjunction with the accompanying drawings, in which:

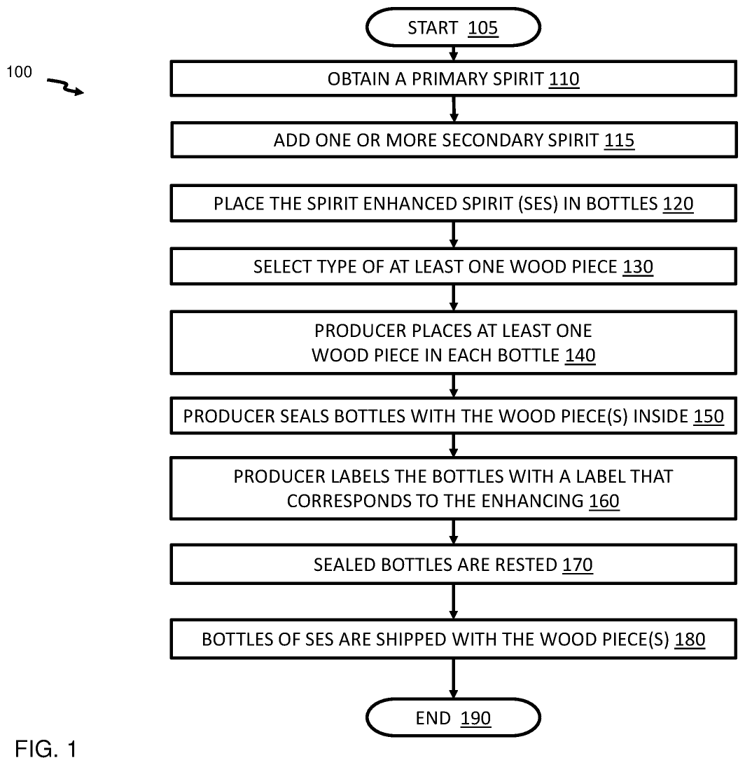

FIG. 1 illustrates a flow diagram of an example of a method of producing a SES according to the principles of the disclosure;

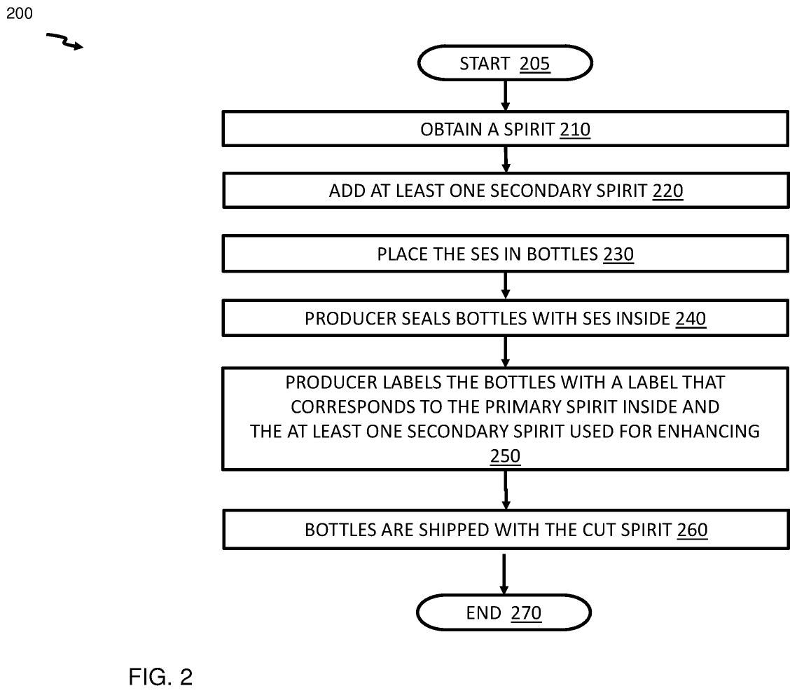

FIG. 2 illustrates a flow diagram of another example of a method of producing a SES according to the principles of the disclosure;

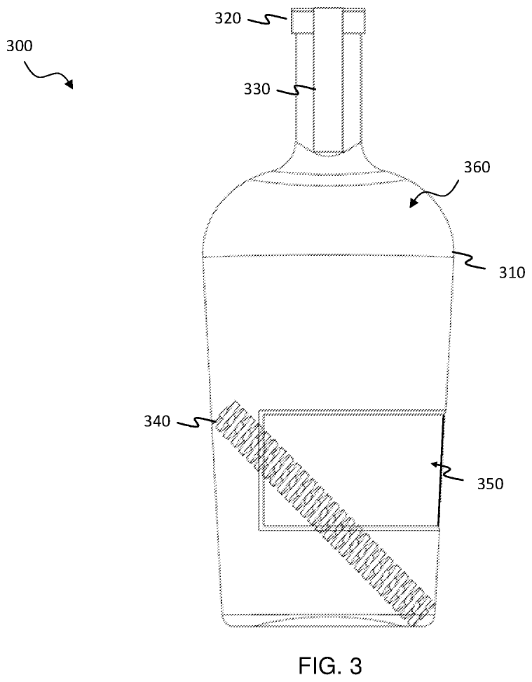

FIG. 3 illustrates an embodiment of a bottle of an SES produced according to the principles of the disclosure;

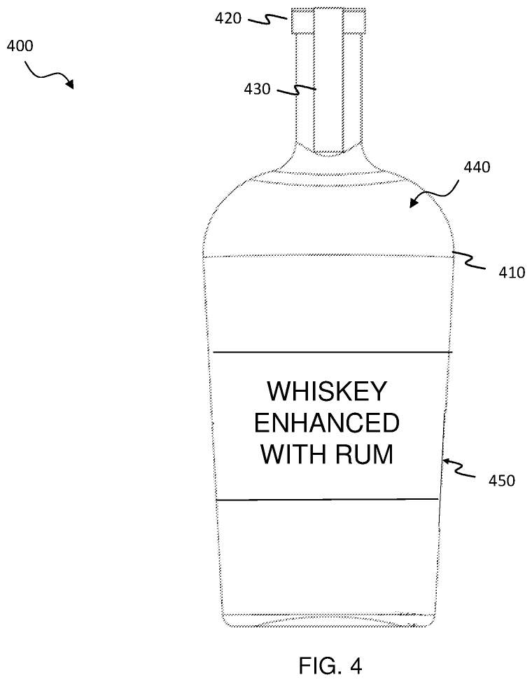

FIG. 4 illustrates an example of another bottle of a SES produced according to the principles of the disclosure; and

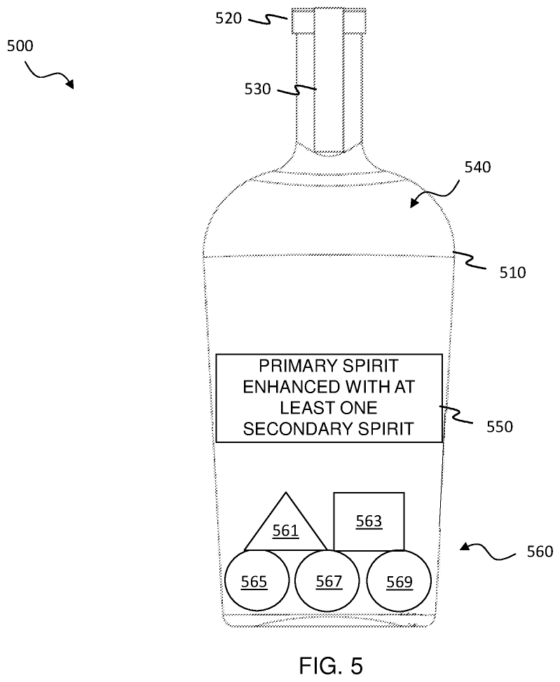

FIG. 5 illustrates an example of yet another bottle of a SES produced according to the principles of the disclosure and including wood pieces for additional enhancing.

### DETAILED DESCRIPTION

Aging is one processing step that can be used to enhance the flavor of a spirit. An additional processing step that can be used for enhancing, referred to as finishing, is sometimes used to add additional flavor to aged distilled spirits before being bottled. Finishing, is a technique whereby aged spirits are placed in a secondary barrel or cask (or even more than one) for further maturation. The secondary cask or casks may have been used previously to age another spirit, like rum, brandy, wine, or beer. A finished spirit is sometimes referred to as double-matured since the spirit is matured in a first cask (aging) and then matured in another cask (a second cask for finishing) of a different origin.

By placing the aged spirit in one or more secondary casks the spirit takes on new, more nuanced flavors from the wood and other elements that are inherent to the secondary cask. This “finishes” the spirit and makes it unique (sanctified). Unfortunately, finishing requires more time in addition to the time used for aging. As such, the cost and time for finishing can outweigh the benefit of a finished spirit. The time required for aging and then finishing can have a chilling effect on the development and delivery of new alcoholic products to the market.

The disclosure provides a method of enhancing a spirit by mixing in one or more other spirit during manufacturing. The primary spirit, i.e., the spirit being enhanced, and the one or more additional spirits, i.e., the secondary spirits, can be a distilled spirit, a non-distilled spirit, an aged spirit, a finished spirit, a spirit that is neither aged nor finished, and any combination thereof. For example, the primary spirit can be silver tequila and secondary spirits of bourbon and wine can be added to the silver tequila during manufacturing to enhance the flavor of the tequila. The enhancing process does not create a new type of liquor but instead adds an additional flavor profile to the primary spirit. As such, the resulting spirit complies with all industry and/or government standards and/or requirements to remain within the definition of the primary spirit.

Accordingly, the disclosure advantageously introduces a process to enhance spirits that does not necessarily require the additional time for aging and/or finishing. Instead, a process is disclosed that utilizes another spirit or spirits to enhance a primary spirit before bottling. A primary spirit that has been enhanced with at least one other different type of spirit is referred to herein as a spirit enhanced spirit (SES). In addition to enhancing with one or more secondary spirits, the SES can be further enhanced with in-bottle finishing.

For in-bottle finishing, at least one wood piece can be used for further maturation or enhancing of the primary spirit after being placed in the bottle. For example, a wood piece can be used for finishing of an aged SES that is in the bottle. Thus, instead of in-cask finishing, in-bottle finishing can also be utilized with an SES. At least one wood piece can be placed in each of the bottles during manufacturing before the bottle is sealed for commercial sale and distribution. Sealing as used herein refers to capping and sealing a SES in a bottle (such as a glass bottle) for commercial sale. Sealing can be performed according to industry standards and via a conventional method including, but not limited to, cork type closures, capsules (including spinning and shrinking), and screw-on caps. Once sealed, the seal is broken and the lid is removed by the purchaser/consumer/server of the bottled SES.

The wood piece can be produced to increase the interaction of wood with the SES in the bottle. As such, the amount of time for finishing of an aged distilled spirit compared to in-cask finishing can be reduced. Since part of the manufacturing process of the SES can include using at least one wood piece, consistency of the wood pieces that are employed for finishing is needed. Accordingly, the wood pieces are produced according to certain parameters to produce a consistent finish across multiple bottles; including bottles having different volumes. One or more wood pieces can also be rested for an amount of time in one or more liquids or non-liquids before being placed in a bottle.

Different types of a wood piece or pieces can be used. The wood pieces can be cut to provide a high ratio of wood surface area to the spirit in a bottle. The wood pieces can be cut to provide an orientation of the wood grain to wood surface for an optimal wood-to-spirit in-bottle interaction. Accordingly, the surface area and grain orientation of the wood piece can be designed to reduce finishing time compared to using a secondary cask. The wood pieces can be wood spires having a high surface area for chemical reaction with the spirit. The design and production of the wood pieces allow the wood to impart desired chemical constituents into the bottled SES, while reacting and removing other chemical constituents (e.g., undesirable chemical constituents) from the bottled SES in accordance with a known volume of the bottle and time used for enhancing. As such, the one or more wood pieces can impart desired chemical constituents into both the primary spirit and the at least one other different type of secondary spirit. Accordingly, the one or more wood pieces can also remove or at least reduce undesired chemical constituents from both the primary spirit and the at least one other different type of secondary spirit.

The wood pieces can also have other shapes, such as spheres, cones, cylinders, or a type of polyhedron. A non-limiting list of different type of polyhedrons that can be used include cubes, pyramids, octahedron, dodecahedron, and icosahedron. Polygons having a higher number of faces, for example an icosahedron compared to a pyramid, can have a higher surface area for chemical reaction with the SES. The various shapes can also be modified such that the surface area of the wood piece is increased. For example, a face(s) or surface(s) of a wood piece can be notched, cut, scored, etc. to increase surface area that can be exposed to the SES. One or more wood pieces of a first shape can be used with one or more wood pieces of a second different shape. The amount of surface area of different wood pieces can vary to provide different levels of interaction with a SES. As such, a producer can control or at least influence the enhancing process and create different flavor profiles in addition to an additional spirit being added to the primary spirit. Various combinations of different shapes and different numbers of each shape can also be used in the same bottle. For example, a spire and a sphere can be placed in the same bottle. Additionally, different combinations of primary and secondary spirits can be used with different variations of wood pieces, resting agents, and resting time.

The different types of liquids or non-liquids used for resting are collectively referred to as resting agents. One or more wood pieces can each be rested in different resting agents before being placed in the bottle. For example, a wood piece can be rested in wine and a second wood piece can be rested in honey and both the first wood piece and the second wood piece can then be placed in the same bottle. Wood pieces of a particular shape can be rested in the same resting agent. For example, cubes can be rested in hibiscus and spheres can be rested in lavender. In some examples, the resting can produce wood pieces of different colors depending on, for example, the type of wood and the resting agent. For example, the spheres rested in lavender can have a purple color that is visible in a bottle of gin.

The amount of resting time can vary depending on empirical data for desired flavor profiles. At some point, absorption can be at least substantially reached where additional resting for a wood piece is not or only negligibly beneficial. The amount of resting time for the wood pieces can be six weeks and can vary depending on the type of wood piece and the resting agent.

Turning now to the figures, FIG. 1 illustrates a flow diagram of an example of a method 100 of producing a SES according to the principles of the disclosure. The method 100 uniquely delivers reproducible flavor profiles to consumers employing mixing one or more secondary spirit with a primary spirit. The method 100 provides sealed bottles of the SES, which is a primary spirit with at least one enhancing secondary spirit. In addition to the enhancement from one or more secondary spirits, at least one wood piece can be used for enhancing after the bottles are sealed. Each of the steps of the method 100 can be performed by a manufacturer as part of the commercial distribution of bottled spirits. The method 100 begins in a step 105.

In a step 110, a primary spirit is obtained. The primary spirit can be a distilled spirit obtained from a producer as an already distilled product or can be produced via, for example, conventional methods. The distilled spirit can be a base liquor, which includes brandy, whisky, bourbon, rum, gin, tequila, mezcal, or vodka. The distilled spirit can be aged. The distilled spirit can be aged by traditional methods such as placing it within wooden barrels for a designated amount of time. The amount of time can vary depending on the type of distilled spirit, different methods used (aging at sea, high altitudes, chemically controlled processes, etc.) or desired results. The primary spirit can be finished in addition to being aged. The primary spirit can be obtained as an aged and/or finished distilled spirit. Additionally, the primary spirit obtained can be a non-distilled spirit, such as wine, beer, sake, or hard cider.

The primary spirit is a manufactured spirit that is in a completed state, which could be sold under the appropriate label according to industry and/or government standards. In other words, if the primary spirit is whiskey, the obtained primary spirit can be bottled and sold as whiskey. The method 100 can enhance the flavor profile of the completed primary spirit.

In a step 115, one or more secondary spirit is added to the primary spirit. Like the primary spirit, the secondary spirit(s) is also in a completed state and could be sold under the appropriate label according to industry and/or government standards. For example, if the secondary spirit is tequila, the obtained secondary spirit can be bottled and sold as tequila. As with the primary spirit, the one or more secondary spirit can be a distilled spirit, such as brandy, whisky, bourbon, rum, gin, tequila, or vodka, or a non-distilled spirit such as wine, beer, sake, or hard cider. In some examples, the one or more secondary spirit can be a certain brand of spirit. For example, instead of just tequila, the secondary spirit may be a Casamigos tequila owned by Diageo plc. The resulting spirit from step 115 is a SES.

The amount of secondary spirit that is mixed with the primary spirit can vary depending on a flavor profile desired by the manufacturer. The amount of the secondary spirit or spirits would not transform the primary spirit into another type of spirit that would prevent the SES from being labeled as the primary spirit when bottled. For example, if the primary spirit is bourbon then the addition of the one or more secondary spirit cannot reduce the alcohol by volume (ABV) to below 40 percent when bottled for distribution. In this example the SES would remain bourbon and would be labeled as such. The label can also include the one or more secondary spirits (and brand if applicable) used to enhance the primary spirit.

While still maintaining the standards for the primary spirit, the amount of a secondary spirit added to the primary spirit can be determined by mixing and tasting. A particular percentage can also be determined, such as a range of 1 to 5 percent of a secondary spirit or spirits in a SES. Obtaining a certain chemical composition of the SES can also be used when determining the mixture amounts.

The SES is placed in bottles in a step 120. A conventional method of bottling according to the industry may be employed to place the SES in bottles. As such, the bottles can be filled with the SES according to industry standards. The bottles are the containers used for distributing the end product of the method 100. For example, the bottles in step 120 are the bottles that will later be sealed by the producer, distributed, and placed on shelves for purchase by the end users. Typically, the bottles are constructed of glass and have a sufficient opening to receive a wood piece as disclosed herein.

The primary spirit and the at least one secondary spirit can be added to the bottle instead of being added together and then place in the bottles. For example, the primary (or secondary spirit) can be placed in the bottle and the secondary spirit (or primary spirit) can then be added to the bottle. The primary spirit and at least one secondary spirit can also be added to the bottles simultaneously. Regardless how added, the primary and at least one secondary spirit can be mixed in the bottle instead of mixed before being placed in the bottle. In some example, the primary and secondary spirit(s) can be simply added together without intentional mixing in the bottle to provide a possible separation of spirits to not only enhance the taste but also the look of the bottle. The end user can then mix the primary and secondary spirits together. Sometimes mixing may occur during shipping.

In a step 130, at least one particular type of wood piece is selected for placement in the bottles with the SES. The type of wood piece selected can correspond to a particular taste profile that is desired; especially in combination with one or more secondary spirits and/or the primary spirit. Several different flavor factors can be selected to obtain a particular flavor profile. The taste profiles can vary by the type of wood of the wood piece and the amount of “toast or char” to which the wood is exposed. The types of wood include, but are not limited to, American oak, French oak, Cherry, Apple, Ash, and Mesquite. The wood piece can be selected from a type of wood that has not been actually used as part of a barrel but is the type of wood that is typically used in one of the barrels for aging of a distilled spirit or a spirit, such as wine, or beer. The wood piece can also be cut from wood barrels that were previously used. The wood piece can also be cut from wood barrels that were previously used for storing non-alcoholic products or liquids, such as tea, coffee, soft drinks, etc.

Toast levels are typically used to represent the amount of toast for the wood piece and are the degrees of heat to which the wood is exposed. The heat applied to the wood or wood piece molecularly changes the wood, causing it to release certain botanicals that are inherent in the wood. In some embodiments, the different toast levels are Light toast, Medium toast, and Heavy toast. The toast levels can correspond to industry standards.

Charring is a chemical process of incomplete combustion of the wood when subjected to high heat. Char levels are the degrees to which the wood or wood piece is exposed to fire. Like toasting, charring wood causes the wood to release different botanicals and flavor essences. Different Char levels is the time or duration that the wood is exposed to fire. In one embodiment, the charring or Char levels that are used include Char 1, Char 2, and Char 3. The Char levels can correspond to industry standards.

A producer can mix and match the wood type, toast levels, and char levels to obtain different flavor profiles for the wood pieces. The producer can also use more than one wood piece and the multiple wood pieces can have a different one of one or more of a wood type, toast level, or char level. For example, one wood piece can be a medium toasted American oak with a char level of 1, and a second wood piece can be light toasted ash with a char level of 2. A combination of different shapes of wood pieces can also be used by the producer. The surface area for the one or more of the different wood pieces can also be different to allow different influences on the primary spirit from the different wood pieces. A resting agent or agents for the different wood pieces can also vary to allow different influences for the primary spirit or the one or more secondary spirits. Accordingly, a combination of surface area and resting agent or agents can be selected to vary and control the influence to the primary and/or the secondary spirits. For example, when using at least two wood pieces and desiring more of an influence on the SES of rum as a resting agent compared to another resting agent, then the surface area of the rum-rested wood piece can be greater than the surface area of the other rested wood piece.

Each of the various types of wood pieces can be constructed to provide reproducible flavor profiles. For example, by employing standard toast and char levels, a producer can create and deliver reproducible flavor profiles to consumers employing in-bottle finishing. Employing a standard design, e.g., same dimensions and surface area, for the wood pieces also assists in delivering reproducible flavor profiles. For example, as noted above the wood pieces can be wood spires. To ensure the delivery of a consistent flavor profile the wood spires can be consistently cut a certain way. In some embodiments, the wood spires can be 5 inches in length (127 mm), ⅝ inches in diameter (15.875 mm), and cut in a spiral shape to expose more wood surface area. Similar construction consistency can be used for the other examples of wood pieces, also. For examples, spheres, cubes, etc. can be reproducibly constructed.

The wood pieces can be cut to provide a desired ratio of the surface area to primary spirit volume within a bottle. Considering again a wood spire as an example, the surface area to volume ratio can be 467 mm² to 750 ml. Wood spires of different dimensions can be used for different sized bottles such that there is a consistent ratio of the wood surface area to the volume of primary spirits regardless the bottle size. In some embodiments, the surface area of the wood relative to the volume of primary spirit is precisely determined to perfectly finish the primary spirit “in-bottle” within a designated amount of time. Using a 750 ml bottle, the surface area to volume ratio can be the aforementioned 467 mm to 750 ml for an in-bottle finishing of six weeks. As noted above, the desired ratio of the surface area to primary spirit volume within a bottle can vary with different wood pieces in the same bottle; this can also affect the resting of a wood piece.

In addition to the wood type, toast level, and char level, the wood pieces can also be rested in one or more resting agent to obtain specific flavor profiles. Before a wood piece is placed in the bottle of a SES, depending on the taste profile that is desired, the wood piece, which can also be toasted or charred, may rest in a separate spirit, such as rum, brandy, wine or beer, to add yet another level of complexity to the final SES. Instead of a spirit, the wood piece can rest in a non-alcoholic product before being place in the bottle. For example, the wood piece can be rested in one or more of coffee, tea, a soft drink, honey, syrup, or another type of non-alcoholic liquid. The wood piece can also be rested in products that are not liquids (i.e., non-liquids), such as cinnamon, nutmeg, allspice, anise, vanilla, mint, or other types of spices. Floral products can also be used, including clover, hibiscus, honeysuckle, lavender, roses, etc. Fruit products, such as apple, orange or another type of citrus, or peach, is another example of non-liquid products that can be used for resting. The non-liquid products can be mixed with water or another type of liquid to create a liquid that can be used for the resting of the wood piece.

As noted above, one or more wood pieces can each be rested in different resting agents before being placed in the bottle. Different resting agents can be selected and used based on the primary spirit and/or the secondary spirit(s). For example, a first resting agent can be selected for a first wood piece based on the primary spirit and one or more other resting agents can be selected for one or more other wood pieces based on one or more of the secondary spirits. The surface area of the different wood pieces can also vary based on the desired amount of influence for the different resting agents on the primary and/or secondary spirits.

After selection of the wood piece, the type of selected wood piece (or pieces) is placed in each of the bottles by the producer in a step 140. The wood pieces can be placed in the bottles by hand or via machine. In some embodiments, multiple of a single type of the wood pieces can be placed in the bottles as long as a consistent reproducible finishing can be performed. For example, a known or desired surface area to volume ratio of wood to primary spirit can be maintained. A different type of wood piece can be placed in different bottles. For example, a French Oak wood piece can be placed in some bottles and a charred oak wood piece can be placed in other bottles. Different wood types of wood pieces can be placed in a single bottle for a mixture of finishing woods. Additionally, multiple wood pieces of the same wood type can be placed in bottles. Wood pieces of different shapes, wood types, char levels, toast level, surface area, resting agent, and any combination thereof can be placed in the same bottle. The different combinations can vary depending on the primary and/or secondary spirits that are used and a desired flavor profile.

In a step 150, the bottles having the SES and their one or more wood piece, are sealed. The bottles can be sealed via conventional procedures typically employed in the alcohol beverage industry. The producer seals the bottles with the one or more wood piece inside. Thus, the method 100 produces sealed bottles of a SES having at least one wood piece designed/cut/manufactured for a selected flavor profile.

A label is added to the bottles in a step 160. The producer can attach labels to the bottles employing conventional methods known in the industry. The labels can reflect the type or types of enhancing that were used. Each of the labels can correspond to the primary and secondary spirits utilized and the type or types of wood pieces that are used for further enhancing. For example, a bottle can include a SES having a primary spirit of bourbon, a secondary spirit of wine, and a wood piece that is toasted American oak. Accordingly, the label would indicate a bourbon that has been enhanced by wine and note a toasted oak finish from an American oak wood piece, such as a spire. The label can also indicate the percentage of secondary spirit or spirits to the primary spirit or other values to represent the enhancing. When the wood piece is rested in a resting agent, the label can also include or note the contribution of the resting to the flavor profile noted on the label. When multiple wood pieces are in the bottle, the label can also include or note the contribution of the combination of flavors. Thus, a consumer can know the type of enhancing that is used with each bottle of SES when purchased.

The sealed bottles of SES with their at least one wood piece are then set aside in a step 170 for a designated amount of time for finishing. The amount of time can be based on empirical data and usually corresponds to the exhaustion or substantial exhaustion of the wood piece or pieces within the bottle. A wood piece is exhausted when it has imparted all or substantially all of the flavor that it can or is intended to impart to the surrounding primary spirit. Typically the designated amount of time for finishing is not changed to ensure consistent enhancing through multiple batches of production. The time for the enhancing, such as in-bottle finishing, corresponds to the completion of the exchange of chemical constituents between the wood piece and the bottled SES. As such, the enhancing process, such as in-bottle finishing, disclosed herein is a function of the wood piece (design, size, production, type, toast, char, resting agent, etc.), liquid volume, and amount of time the sealed bottle is rested. The values of the variables of the enhancing process can be changed to provide the contribution of organic compounds to transform acids into esters to give the bottled SES the desired unique flavor. In some embodiments, a taste test is used to determine a desired product taste and the combination and values of the variables used to provide the desired product taste are selected for manufacturing and consistent reproduction of the SES product.

Considering the wood spired discussed above as an example, once the spire is placed in-bottle, the bottle can be rested for six weeks before it is distributed or sold for consumption to allow sufficient time for the wood spire to enhance (sanctify) the SES. As the SES product ages beyond six weeks, the flavor profiles typically will not change, but the product can become smoother and less harsh.

In a step 180, the bottles of SES with at least one wood piece are shipped. At this point, the producer has completed the production process and the SES is ready to be distributed and enjoyed by the consumer. The amount of time for shipping can be considered in the amount of time for enhancing, such as in step 170. The method 100 ends in a step 190.

One skilled in the art will understand that at least some of the steps of the method 100 can be performed in a different order than disclosed herein. For example, bottles can be labeled before adding the SES and/or the at least one wood piece. Additionally, the wood piece can be added before the SES. The primary spirit and the one or more secondary spirit can also be added to the bottle separately and can be placed in the bottle in no particular order with respect to each other and the wood piece.

FIG. 2 illustrates a flow diagram of another example of a method 200 of producing a SES according to the principles of the disclosure. The method 200 provides sealed bottles of the SES, which includes a primary spirit with at least one enhancing secondary spirit. The method 200 uniquely delivers reproducible flavor profiles to consumers employing at least one secondary spirit added to a primary spirit. Each of the steps of the method 200 can be performed by a manufacturer as part of the commercial distribution of bottled spirits. The method 200 begins in a step 205.

In a step 210, a primary spirit is obtained. As with step 110 of method 100, the primary spirit can be a distilled spirit obtained from a producer as an already distilled product or can be produced via, for example, conventional methods. The distilled spirit can be a whisky, bourbon, rum, gin, tequila, etc. The distilled spirit can be aged. The distilled spirit can be aged by traditional methods such as placing it within wooden barrels for a designated amount of time. The distilled spirit can also be finished. The primary spirit can be finished in addition to being aged. The primary spirit can be obtained as an aged and/or finished distilled spirit. Additionally, the primary spirit obtained can be a non-distilled spirit, such as wine or beer.

In a step 220, at least one secondary spirit is added to the primary spirit. The resulting spirit is a SES. The step of 220 can be performed as discussed above with respect to step 115 of FIG. 1.

The SES is placed in bottles in a step 230. As with step 120, the bottles are typically constructed of glass and a conventional method of bottling according to the industry may be employed to place the SES in bottles. As such, the bottles can be filled with the SES according to industry standards used for distributing the end product of the method 200. For example, the bottles in step 230 are the bottles that will later be sealed by the producer, distributed, and placed on shelves for purchase by the end users.

As noted above regarding step 120, the primary spirit and the at least one secondary spirit can be added to the bottle instead of being added together and then placed in the bottles. The primary spirit and at least one secondary spirit can be added to the bottles simultaneously and can be mixed in the bottle instead of mixed before being placed in the bottle. The primary and secondary spirit(s) can also be added together without intentional mixing in the bottle to provide a possible separation of spirits to not only enhance the taste but also the look of the bottle. The end user can then mix the primary and secondary spirits together. In step 240, the bottles having the SES are sealed. The bottles can be sealed via conventional procedures typically employed in the alcohol beverage industry. Thus, the method 200 produces sealed bottles of a SES.

A label is added to the bottles in a step 250. The producer can attach labels to the bottles employing conventional methods known in the industry. Each of the labels can correspond to the primary spirit and indicate the secondary spirit or spirits used for enhancing. For example, the label can indicate a whiskey enhanced with a rum. The label can also indicate the percentage of secondary spirit or spirits to primary spirit or other values to represent the enhancing.

In a step 260, the bottles of SES are shipped. At this point, the producer has completed the production process and the SES is ready to be distributed and enjoyed by the consumer. The method 200 ends in a step 270. One skilled in the art will understand that at least some of the steps of the method 200 can be performed in a different order than disclosed herein. For example, bottles can be labeled before adding the SES spirit.

FIG. 3 illustrates an embodiment of a bottle 300 of an SES produced according to the principles of the disclosure. The bottle 300 includes a body 310, a lid or cap 320, a seal 330, a wood piece 340, a label 350, and a SES 360 within a volume defined by the body 310. The bottle 300 is constructed of a non-permeable material. For example, the bottle 300 is made of a glass that is typically used for bottling liquor. The bottle 300 is of an SES that employs additional enhancing with in-bottle finishing. The bottle 300 is ready for commercial sale. For example, the bottle 300 is ready to be placed on shelves for purchase by consumers. The bottle 300 is an example of a bottle produced by the method 100.

The body 310 defines the shape and volume of the bottle 300. The body 310 has an inner and outer surface. The body 310 is collectively representing the base, heel, shoulder, etc., and other known parts of a bottle.

The lid 320 is used to cover the orifice of the bottle 300. The lid 320 can be cork, a screw cap, or another type of lid that is conventionally used.

The seal 330 is used to secure the lid 320 and indicate no tampering from the producer to the consumer. Conventional types of seals can be used. As illustrated, the bottle 300 is capped and sealed after the wood piece 340 is placed in the bottle 300. Since the bottle 300 is for commercial sale, the seal 330 is unbroken.

The wood piece 340 is placed in the bottle 300 before the lid 320 and the seal 330 are placed thereon. The wood piece 340 can be a spire as illustrated or have another configuration, such as a cylinder, a cuboid, or another similar 3D shape. As disclosed herein, the wood piece 340 can be designed to correspond to the volume of the bottle 300 and a desired finishing time. When first placed in the bottle 300 with the SES 360, the wood piece 340 will float. The wood piece 340 absorbs the SES 360 during the process of exchanging chemical constituents with the SES 360 and sinks to the bottom of the bottle 300. In FIG. 3, the wood piece 340 is saturated with the SES 360 and has sunk to the base of the bottle 300.

The label 350 indicates the primary spirit of the SES and the enhancements, such as one or more secondary spirits and the type of wood piece 340 within the bottle 300. The label 350 can be attached to the bottle 300 via a conventional procedure. The body 310 can include an indentation area (not identified in FIG. 3) that corresponds to a shape and size of the label 350 and the label 350 can be placed within the indentation section. The bottle 300 with lid 320, seal 330, wood piece 340, label 350 and SES 360, can be shipped for commercial distribution and sale. As noted herein, the wood piece 340 can be rested in another liquid before being placed in the bottle 300. The other liquid can be a spirit that is different than the primary spirit of the SES 360, different than the one or more secondary spirits of the SES 360, can be the same type of either one of the primary or secondary spirits of the SES 360, or a non-alcoholic liquid. When the wood piece is rested, the label 350 reflects the contribution of the resting to the flavor profile. The wood piece can be infusion spirals commercially available from, for example, The Barrel Mill in Central Minnesota.

FIG. 4 illustrates an example of another bottle 400 of a SES produced according to the principles of the disclosure. The bottle 400 includes a body 410, a lid or cap 420, a seal 430, a SES 440, and a label 450. The SES 440 is within a volume defined by the body 410. The bottle 400 is constructed of a non-permeable material. For example, the bottle 400 is made of a glass that is typically used for bottling liquor. The bottle 400 is ready to be sold, either wholesale or retail, and enjoyed by consumers. The bottle 400 is an example of a bottle produced by the method 200.

The body 410, lid 420, and seal 430, can correspond to similar items described herein, such as the body 310, the lid 320, and the seal 330. Since the bottle 400 is for commercial sale, the seal 430 is unbroken.

The SES 440 includes a primary spirit and at least one secondary spirit. The label 450 indicates the primary spirit of the SES 440 and the one or more secondary spirits used for enhancing. For example, as shown in FIG. 4 the label 450 can indicate a whiskey that is enhanced with a rum. The label 450 can also indicate the percentage of secondary spirit or spirits to primary spirit or other values to represent the enhancing. The label 450 can be attached to the bottle 400 via a conventional procedure as noted in step 250. The bottle 400 with body 410, lid 420, seal 430, SES 440, and label 450, can be shipped for commercial distribution and sale.

FIG. 5 illustrates an example of yet another bottle 500 of a SES produced according to the principles of the disclosure and including wood pieces for additional enhancing. The bottle 500 includes a body 510, a lid or cap 520, a seal 530, a SES 540, a label 550 and wood pieces 560. The SES 540 and the wood pieces 560 are within a volume defined by the body 510. The bottle 500 is constructed of a non-permeable material, such as glass, and is ready for commercial sale. For example, the bottle 500, as with bottles 300 and 400, is ready to be placed on shelves for purchase by consumers or to be used by a bartender.

The body 510 defines the shape and volume of the bottle 500. The body 510 has an inner and outer surface. The body 510 is collectively representing the base, heel, shoulder, etc., and other known parts of a bottle. The lid 520 is used to cover the orifice of the bottle 500, which is sized to receive the wood pieces 560. The lid 520 can be cork, a screw cap, or another type of lid that is conventionally used. The seal 530 is used to secure the lid 520 and indicate no tampering from the producer to the consumer. Conventional types of seals can be used. As illustrated, the bottle 500 is capped and sealed after the wood pieces 560 are placed in the bottle 500. Since the bottle 500 is for commercial sale, the seal 530 is unbroken in FIG. 5.

The wood pieces 560 are placed in the bottle 500 before the lid 520 and the seal 530 are placed thereon. The wood pieces 560 include a pyramid 562, a cube 563, and spheres 565, 567, and 569. One of more of the wood pieces 560 can be different types of woods, with different toast levels, char levels, or neither no toast nor char. The surface area of one or more of the wood pieces 560 can also be different. One or more of the wood pieces 560 can also be rested wood pieces that have rested in a resting agent or agents before being placed in the bottle 500. A combination of the wood pieces 560 rested in different resting agents can be used. For example, the pyramid 561 can be rested in a first resting agent and the cube 563 can be rested in different resting agent. One or more of the spheres 565, 567, 569, can be rested in one of the same resting agents or yet in a third resting agent. Each of the spheres 565, 567, 569, can be rested in the same resting agent. The different resting agents can be selected based on the primary spirit and/or the one or more secondary spirits. The different wood pieces 560 can inherent a color from their resting agent that can provide a pleasing visual presentation in the bottle 500 along with the functional enhancing of the primary spirit 540. The wood pieces 560 can have other shapes than those shown in FIG. 5 and the number of wood pieces can vary. As disclosed herein, the wood pieces 560 can be designed, such as to have a particular surface area, to correspond to the volume of the bottle 500 and a desired time for enhancing the spirit. The different wood pieces 560 can also be designed or selected based on a desired influence from the particular wood pieces 560 on the primary or secondary spirits based on characteristics of the different wood pieces, resting agents, or a combination thereof. When first placed in the bottle 500 with the distilled primary spirit 540, the wood pieces 560 will float. The wood pieces 560 absorb the SES 540 during the process of exchanging chemical constituents with the SES 540 and sink to the bottom of the bottle 500. In FIG. 5, the wood pieces 560 are saturated with the SES 540 and have sunk to the base of the bottle 500.

The label 550 corresponds to the type of wood pieces 560 within the bottle 500, the primary spirit of the SES 540 and the one or more secondary spirit added to the primary spirit. The label 550 can be attached to the bottle 500 via a conventional procedure. The bottle 500 with lid 520, seal 530, SES 540, label 550 and wood pieces 560, can be shipped for commercial distribution and sale. When one or more of the wood pieces are rested, the label 550 reflects the contribution of the resting to the flavor profile.

Those skilled in the art to which this application relates will appreciate that other and further additions, deletions, substitutions and modifications may be made to the described embodiments. For example, variations of commercially producing a primary spirit enhanced with at least one secondary spirit, including primary and/or secondary spirits that are not distilled, may also be used. Using one or more wood pieces and/or resting agents are examples of further enhancements

What is claimed is:

1. A method of producing a spirit enhanced spirit (SES), comprising:
obtaining a primary spirit;
adding one or more secondary spirit to the primary spirit, wherein the one or more secondary spirit is a different type of spirit than the primary spirit;
placing the primary spirit and the one or more secondary spirit in a bottle, wherein combination of the primary spirit with the one or more secondary spirit produces a SES; and
sealing the bottle.

2. The method as recited in claim 1, wherein the primary spirit is a first spirit of a base liquor and the one or more secondary spirit is a single spirit that is a second spirit of a base liquor that is different than the first spirit.

3. The method as recited in claim 1, wherein at least two secondary spirits are combined with the primary spirit.

4. The method as recited in claim 3, wherein at least one of the two secondary spirits is a non-distilled spirit and the other one of the two secondary spirits is a distilled spirit.

5. The method as recited in claim 3, wherein the two secondary spirits are a same type of spirit and each one of the two secondary spirits have been aged differently.

6. The method as recited in claim 1, wherein the one or more secondary spirit is a particular brand.

7. The method as recited in claim 1, wherein at least one of the primary spirit or the one or more secondary spirit is a non-distilled spirit.

8. The method as recited in claim 1, wherein at least one of the primary spirit or the one or more secondary spirit is a distilled spirit.

9. The method as recited in claim 1, wherein at least one of the primary spirit or the one or more secondary spirits is an aged, distilled spirit.

10. The method as recited in claim 1, wherein steps of the method are performed by a manufacturer for commercial distribution of the SES bottles.

11. The method as recited in claim 1, further comprising placing a label on the bottle, wherein the label identifies the SES as the primary spirit.

12. A method of producing a SES for commercial distribution, comprising:
obtaining a primary spirit;
adding one or more secondary spirit to the primary spirit, wherein the one or more secondary spirit is a different type of spirit than the primary spirit;
placing the primary spirit and the one or more secondary spirit in a bottle;
placing at least one wood piece in the bottle; and
sealing the bottle, having located within the bottle both the primary spirit, the one or more secondary spirit, and the wood piece.

13. The method as recited in claim 12, wherein the at least one wood piece has been rested in a resting agent.

14. The method as recited in claim 13, wherein at least two of the primary spirit, the one or more secondary spirit, and the resting agent are distilled spirits.

15. The method as recited in claim 12, wherein at least two wood pieces are placed in the bottle and each one of the wood pieces has a different surface area.

16. The method as recited in claim 15, wherein each of the at least two wood pieces are rested in different resting agents.

17. The method as recited in claim 12, wherein the one or more secondary spirit is a particular brand.

18. The method as recited in claim 12, further comprising placing a label on the bottle, wherein the label identifies the SES as the primary spirit.

19. The method as recited in claim 18, wherein each of the steps of the method are performed by a manufacturer before shipping the SES bottle.

20. A method of manufacturing a spirit enhanced spirit (SES) for commercial sale, comprising:
obtaining a primary spirit that is a base liquor;
adding at least one secondary spirit to the primary spirit, wherein the at least one secondary spirit is a different base liquor than the primary spirit;
placing the primary spirit and the at least one secondary spirit in a bottle, wherein combination of the primary spirit with the one or more secondary spirit produces a SES;
sealing the bottle; and
placing a label on the bottle, wherein the label identifies the SES as the primary spirit and includes the secondary spirit.
